(19) United States
(12) Patent Application Publication
(10) Pub. No.: US 2025/0208597 A1
(43) Pub. Date: Jun. 26, 2025

(54) ENDPOINT DETECTION BY GENERATING SYNTHETIC SENSOR DATA

(71) Applicant: Applied Materials, Inc., Santa Clara, CA (US)

(72) Inventors: Lei Lian, Fremont, CA (US); Quentin Ernie Walker, Fremont, CA (US); Serghei Malkov, Hayward, CA (US); Richard Hansen, Santa Clara, CA (US); Jeremy Smith, San Mateo, CA (US); Dermot Patrick Cantwell, Sunnyvale, CA (US)

(21) Appl. No.: 18/395,043

(22) Filed: Dec. 22, 2023

(51) Int. Cl. G05B 19/18

(52) U.S. Cl. CPC G05B 19/188; G05B 2219/45031

(57) ABSTRACT

A method includes providing, to a trained machine learning model, first OES time trace data from a substrate processing operation. The first OES time trace data is of a first set of wavelengths. The method further includes obtaining, from the trained machine learning model, synthetic OES time trace data of the substrate processing operation, the synthetic OES time trace data being of a second set of wavelengths, different than the first. The method further includes obtaining second OES time trace data from the substrate processing operation of the second set of wavelengths. The method further includes determining, based on the synthetic OES time trace data and the second OES time trace data, a process endpoint for the substrate processing operation. The method further includes performing an action in view of the process endpoint.

### TECHNICAL FIELD

The present disclosure relates to methods associated with endpoint detection of manufacturing processes. More specifically, the present disclosure related to methods of endpoint detection by generating synthetic sensor data.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Machine learning models are used in various process control and predictive functions associated with manufacturing equipment. Machine learning models are trained using data associated with the manufacturing equipment. Process endpointing may be performed to ensure that durations of processing operations conform to standards for generating products with target properties.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In some aspects of the present disclosure, a method includes providing, to a trained machine learning model, first optical emission spectroscopy (OES) time trace data from a substrate processing operation. The first OES time trace data is of a first set of wavelengths. The method further includes obtaining, from the trained machine learning model, synthetic OES time trace data of the substrate processing operation, the synthetic OES time trace data being of a second set of wavelengths, different than the first. The method further includes obtaining second OES time trace data from the substrate processing operation of the second set of wavelengths. The method further includes determining, based on the synthetic OES time trace data and the second OES time trace data, a process endpoint for the substrate processing operation. The method further includes performing an action in view of the process endpoint.

In some aspects of the present disclosure, a non-transitory machine-readable storage medium stores instructions which, when executed by a processing device, cause the processing device to perform operations. The operations include providing, to a trained machine learning model, first OES time trace data from a substrate processing operation. The first OES time trace data is of a first set of wavelengths. The operations further include obtaining, from the trained machine learning model, synthetic OES time trace data of the substrate processing operation, the synthetic OES time trace data being of a second set of wavelengths, different than the first. The operations further include obtaining second OES time trace data from the substrate processing operation of the second set of wavelengths. The operations further include determining, based on the synthetic OES time trace data and the second OES time trace data, a process endpoint for the substrate processing operation. The operations further include performing an action in view of the process endpoint.

In some aspects of the present disclosure, a system includes memory and a processing device coupled to the memory. The processing device is configured to provide, to a trained machine learning model, first OES time trace data from a substrate processing operation. The first OES time trace data is of a first set of wavelengths. The processing device is further configured to obtain, from the trained machine learning model, synthetic OES time trace data of the substrate processing operation, the synthetic OES time trace data being of a second set of wavelengths, different than the first. The processing device is further configured to obtain second OES time trace data from the substrate processing operation of the second set of wavelengths. The processing device is further configured to determine, based on the synthetic OES time trace data and the second OES time trace data, a process endpoint for the substrate processing operation. The processing device is further configured to perform an action in view of the process endpoint.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for performing operations associated with process endpointing, according to some embodiments.

FIG. 5 is a block diagram of a data flow for generating, verifying accuracy of, and/or using a machine learning model for endpointing based on responsive and non-responsive sensor channels, according to some embodiments.

FIG. 6 is a block diagram illustrating a computer system, according to some embodiments.

### DETAILED DESCRIPTION

Described herein are technologies related to endpointing process operations of a substrate processing system. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. Manufacturing systems may maintain property values of the system for an amount of time to perform a process on a substrate, such as an etch operation, deposition operation, or the like. Manufacturing systems may utilize endpointing operations to determine a duration to perform one or more operations to achieve target substrate properties.

In some systems, determining to end a process operation may be based on a process recipe. For example, some process operations may be terminated after a target duration of processing. Recipe or duration-based process endpointing may suffer from an inability to adapt processing operations for a variety of conditions, such as differences between conditions of substrates provided for processing, differences in process chambers, differences in processing conditions, differences in chamber efficiency or performance, differences in components included in the manufacturing system, or the like.

In some systems, determining to end a process operation may be based on sensor data indicative of process endpoint. For example, data from one or more sensors may exhibit or include a change (e.g., in value, slope, concavity, or the like) related to progress and/or endpoint of a process operation in progress. In one example, an optical emission spectrometer (OES) device may measure spectral data of a plasma in an etch process. Spectral data may include indications of process endpoint. Utilizing sensor data for determining process endpoint may suffer from determining which sensor channels are related to endpoints for a variety of substrate designs, variety of process operations, a variety of process conditions, etc. In some cases, a substrate design, process operation, or the like may obscure indications of process endpoints in sensor data. For example, substrates with a dense pattern (e.g., low open area), substrates with deep trenches, channels, holes, or features, or other more complex or specialized substrates may not provide clear indications of process endpoint in a sensor channel.

In some systems, efforts have been made to improve endpointing based on sensor data of a process operations. One strategy for improving endpointing includes utilizing several sensor channels together, which may provide a more distinct endpoint signal than any individual sensor channel. For example, two wavelengths of a OES data may be utilized together to perform endpointing. Intensity of a signal from a first channel may be subtracted from, normalized by, or subjected to another function to combine information from the first sensor channel with a second sensor channel. Such an approach may have shortcomings, including a large number of possible combinations of data to search for endpointing viability, possibility of simple functions not enhancing an endpointing signal sufficiently for some processes, etc.

Another strategy that may be utilized for improving endpointing includes utilizing a reference (e.g., reference substrate, reference process operation, etc.) to correct a sensor signal for enhancing an endpointing signal. Such strategies may have shortcomings related to applicability of the reference substrate or reference operations to the operation of interest, additional cost associated with performing process operations on a reference substrate, etc.

Methods and systems of the present disclosure may address one or more shortcomings of conventional solutions. In some embodiments, OES data of a plasma may be utilized for endpointing process operations. OES data may be utilized along with additional sensor data, such as radio frequency (RF) characteristics, electrical properties, or the like. OES data of the plasma (and, in some embodiments, additional sensor data of the process chamber) may be provided to a trained machine learning model that is configured to perform endpointing operations for the substrate processing procedure. The machine learning model may determine when a process operation has been completed, may cause the process operation to be stopped, may cause a subsequent process operation to begin, may update a process recipe, or the like.

In some embodiments, the machine learning model may be configured to perform endpointing operations based on a distinguishing between responsive and non-responsive sensor channels (e.g., responsive and non-responsive wavelengths). Responsive sensor channels (e.g., responsive wavelengths), as used herein, are sensor channels with a comparatively large response to process endpoint. Non-responsive sensor channels are sensor channels with a small response to process endpoint.

In some embodiments, a machine learning model may be configured to predict behavior of responsive sensor channels based on behavior of non-responsive channels. Determining whether a sensor channel (e.g., time trace sensor value, OES wavelength intensity measurement value, or the like) is responsive or non-responsive may include performing sensor measurements of a process. Determining responsive and non-responsive channels may include performing measurements of a process that experiences a process endpoint (e.g., a layer of material it etched away in an etch process, revealing a lower layer with different properties at the endpoint of the etch process). Determining responsive and non-responsive sensor channels may include performing measurement of a process that does not experience a process endpoint (e.g., performing an etch process on a substrate that has a thick layer of a first material which is predicted to persist beyond a maximum time duration of the process). Determining responsive and non-responsive sensor channels may include making comparisons between behavior of the process that includes an endpoint signal and the process that does not include an endpoint signal.

In some embodiments, a machine learning model may be configured to receive, as input, data from one or more non-responsive channels, and predict the data of responsive channels based on the non-responsive channels. For example, the machine learning model may be configured to receive time trace data of non-responsive wavelengths, and predict behavior of the responsive wavelengths based on the non-responsive wavelengths. Differences between predicted behavior and measured behavior of the responsive channels may include indications of process endpoint.

Aspects of the present disclosure provide technological advantages over conventional methods. By providing sensor data to a trained machine learning model for endpointing, data from a large number of sensor channels may be combined in complicated and/or non-linear ways to generate an endpointing signal. By generating predictions of responsive wavelengths (e.g., predicting behavior if the process does not experience an endpoint) may include the advantages of utilizing a reference substrate, without the additional expense of processing, measuring, and disposing of reference substrates. Further disadvantages associated with generating reference wafers periodically may further be avoided, such as additional processing time, reduced productive time of process equipment, additional material usage, additional process equipment wear, additional energy consumption, additional environmental impact, etc. By generating predictions based on sensor data, subtle differences between predictions and measurements may be utilized for endpointing, e.g., differences that would be difficult or impossible to extract without reference data (e.g., predicted data). Utilizing methods and systems of the present disclosure may improve accuracy of endpointing, reduce cost of performing endpointing operations, or both over conventional methods.

In one aspect of the present disclosure, a method includes providing, to a trained machine learning model, first OES time trace data from a substrate processing operation. The first OES time trace data is of a first set of wavelengths. The method further includes obtaining, from the trained machine learning model, synthetic OES time trace data of the substrate processing operation, the synthetic OES time trace data being of a second set of wavelengths, different than the first. The method further includes obtaining second OES time trace data from the substrate processing operation of the second set of wavelengths. The method further includes determining, based on the synthetic OES time trace data and the second OES time trace data, a process endpoint for the substrate processing operation. The method further includes performing an action in view of the process endpoint.

In another aspect of the present disclosure, a non-transitory machine-readable storage medium stores instruction which, when executed, cause a processing device to perform operations. The operations include providing, to a trained machine learning model, first OES time trace data from a substrate processing operation. The first OES time trace data is of a first set of wavelengths. The operations further include obtaining, from the trained machine learning model, synthetic OES time trace data of the substrate processing operation, the synthetic OES time trace data being of a second set of wavelengths, different than the first. The operations further include includes obtaining second OES time trace data from the substrate processing operation of the second set of wavelengths. The operations further include determining, based on the synthetic OES time trace data and the second OES time trace data, a process endpoint for the substrate processing operation. The operations further include performing an action in view of the process endpoint.

In another aspect of the present disclosure, a system includes memory and a processing device coupled to the memory. The processing device is configured to provide, to a trained machine learning model, OES time trace data from a substrate processing operation, the first OES time trace data being of a first set of wavelengths. The processing device is further configured to obtain, from the trained machine learning model, synthetic OES time trace data of the substrate processing operation, the synthetic OES time trace data being of a second set of wavelengths, different than the first. The processing device is further configured to obtain second OES time trace data from the substrate processing operation of the second set of wavelengths. The processing device is further configured to determine, based on the synthetic OES time trace data and the second OES time trace data, a process endpoint for the substrate processing operation. The processing device is further configured to perform an action in view of the process endpoint.

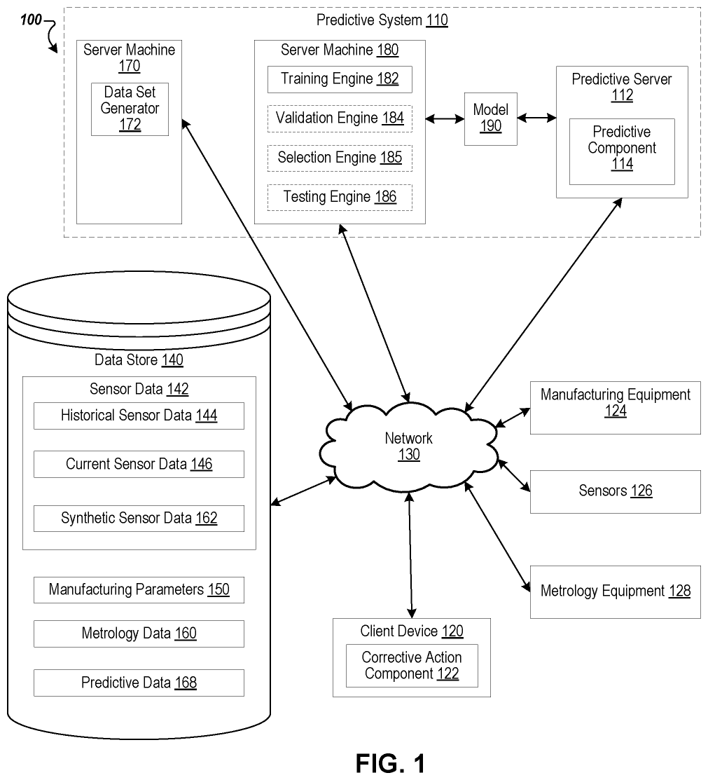

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc.

Sensors 126 may include an optical emission spectrometer (OES), and sensor data 142 may include associated OES data. OES data may be spectral data, e.g., data associated with intensity (such as signal strength, energy, electric field strength, etc.) of a detected wave of energy for a set, band, or range or wavelengths of a detected wave of electromagnetic radiation. An OES sensor assembly may include components for directing light from a light source to a detection component, such as one or more mirrors, prisms, optical fibers, windows, etc. an OES sensor assembly may receive electromagnetic radiation emitted from a plasma of manufacturing system 100, and convert signals generated by the radiation into OES data.

An OES assembly of sensors 126 may include an optical sensor or light detector that measures emissions of a plasma within manufacturing equipment 124, e.g., during an etch operation of manufacturing system 100. The light detector may include or act as an optical emission spectrometer. The OES assembly may enable analysis of radiation received from manufacturing equipment 124, e.g., identifying emission peaks in the signal, identifying emission patterns in the signal, generating spectra, generating time trace data of various wavelength ranges, or the like. The OES data may be provided to one or more processing devices for further processing, e.g., of client device 120, predictive system 110, or the like. OES data may be utilized for training model 190, for inference operations of model 190, etc. In some embodiments, synthetic sensor data 162 may include synthetic OES data, may be based on OES data input to a model, etc.

Sensor data 142 may include historical sensor data 144 and current sensor data 146. Current sensor data 146 may be associated with a product currently being processed, a product recently processed, a number of recently processed products, etc. Current sensor data 146 may be used as input to a trained machine learning model, e.g., to generate predictive data 168, synthetic sensor data 162, etc. Historical sensor data 144 may include data stored associated with previously produced products. Historical sensor data 144 may be used to train a machine learning model, e.g., model 190. Historical sensor data 144 and/or current sensor data 146 may include attribute data, e.g., labels of manufacturing equipment ID or design, sensor ID, type, and/or location, label of a state of manufacturing equipment, such as a present fault, service lifetime, etc.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Sensor data 142 may be associated with components or subsystems controlled by closed loop control, feedback control, model-based control, or the like, such as radio frequency (RF) parameters, including RF power, RF voltage, RF match inductance, or the like. Data associated with some hardware parameters and/or process parameters may, instead or additionally, be stored as manufacturing parameters 150, which may include historical manufacturing parameters (e.g., associated with historical processing runs) and current manufacturing parameters. Manufacturing parameters 150 may be indicative of input settings to the manufacturing device (e.g., heater power, gas flow, etc.). Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates may have property values (film thickness, film strain, etc.) measured by metrology equipment 128, e.g., measured at a standalone metrology facility. Metrology data 160 may be a component of data store 140. Metrology data 160 may include historical metrology data (e.g., metrology data associated with previously processed products).

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data (e.g., metrology data associated with a product currently or recently processed).

In some embodiments, sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). Sensor data 142 may include features and the features may be used by predictive component 114 for performing signal processing and/or for obtaining synthetic sensor data 162 for endpointing operations, obtaining predictive data 168 for performance of a corrective action, or the like.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g., information indicative that a set of sensor data, a set of metrology data, and a set of manufacturing parameters are all associated with the same product, manufacturing equipment, type of substrate, etc.

In some embodiments, a processing device (e.g., via a machine learning model) may be used to generate synthetic sensor data 162. Synthetic data may be processed in any of the ways described above in connection with other types of data, e.g., generating features, combining values, linking data from a particular recipe, chamber, or substrate, etc. Synthetic sensor data 162 may share features with other sensor data 142, e.g., synthetic sensor data 162 may be or include predicted sensor data associated with a substrate process operation. In some embodiments, a machine learning model may predict sensor data for an operation. In some embodiments, a machine learning model may predict sensor data for some sensors or sensor channels (e.g., some OES wavelengths) based on input sensor data. Synthetic sensor data 162 may include predicted sensor data in sensor channels (e.g., wavelengths) that are sensitive to a process endpoint, based on input data from sensor channels that are not sensitive to a process endpoint. Synthetic sensor data 162 may be considered to be synthetic sensor data of a process that does not experience a process endpoint, and differences between synthetic sensor data 162 and current sensor data 146 may be indicative of process endpoints in a current, live, or recent process.

In some embodiments, predictive system 110 may generate predictive data 168 using supervised machine learning (e.g., predictive data 168 includes output from a machine learning model that was trained using labeled data, such as sensor data labeled with metrology data (e.g., which may include synthetic microscopy images generated according to embodiments herein, etc.). In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110. In some embodiments, predictive data 168 may include recommended corrective actions predicted to improve performance of the manufacturing system 100.

In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 (e.g., historical metrology data) corresponds to historical property data of products (e.g., products processed using manufacturing parameters associated with historical sensor data 144 and historical manufacturing parameters of manufacturing parameters 150) and predictive data 168 is associated with predicted property data (e.g., of products to be produced or that have been produced in conditions recorded by current sensor data 146 and/or current manufacturing parameters). In some embodiments, predictive data 168 is or includes predicted metrology data (e.g., virtual metrology data, virtual synthetic microscopy images) of the products to be produced or that have been produced according to conditions recorded as current sensor data 146, current measurement data, current metrology data and/or current manufacturing parameters. In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control. In some embodiments, predictive data 168 may be utilized for endpointing one or more process operations.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into predictive system 110, receiving output of predictive data 168 and/or synthetic sensor data 162, and performing a corrective action such as process endpointing based on the predictive data 168 and/or synthetic sensor data 162, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting sensor data 142 (e.g., OES data, additional sensor data), metrology data, measurement data, etc., receiving output of predictive data 168, and performing corrective action (e.g., process endpointing, predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting sensor data into a model, receiving output of predictive data 168 (e.g., indicative of process endpointing), and performing a corrective action of updating manufacturing parameters (e.g., setting optimal manufacturing parameters, endpointing the process, etc.), system 100 can have the technical advantage of using optimal manufacturing parameters (e.g., hardware parameters, process durations, process parameters, optimal design) to avoid costly results of suboptimal manufacturing parameters.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, process endpointing, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, a machine learning model is trained to monitor the progress of a processing run (e.g., monitor in-situ sensor data to predict if a manufacturing process has reached completion). In some embodiments, the machine learning model may send instructions to end a processing run when the model determines that the process is complete. In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters. In some embodiments performance of a corrective action may include retraining a machine learning model associated with manufacturing equipment 124. In some embodiments, performance of a corrective action may include training a new machine learning model associated with manufacturing equipment 124.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current sensor data 146, and/or current manufacturing parameters (e.g., receive from the client device 120, retrieve from the data store 140) and generate output (e.g., synthetic sensor data 162, predictive data 168, etc.) for performing corrective action associated with the manufacturing equipment 124 based on the current data. In some embodiments, predictive data 168 may include one or more predicted dimension measurements of a processed product. In some embodiments, predictive component 114 may use one or more trained machine learning models 190 to determine the output for performing the corrective action based on current data.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126 including OES data), manufacturing parameters 150 (e.g., associated with process control of manufacturing equipment 124), metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives current sensor data 146, current metrology data 166 and/or current manufacturing parameters 154, performs signal processing to break down the current data into sets of current data, provides the sets of current data as input to a trained model 190, and obtains outputs indicative of predictive data 168 from the trained model 190. Predictive component 114 may receive OES data and potentially other sensor data, provide that data as input to model 190, and receive as output from model 190 synthetic sensor data 162, e.g., predictions of trace data from different sensors or sensor channels based on the input sensor data. Predictive component 114 may receive OES data of wavelengths that are non-responsive to endpointing, and utilize that sensor data to predict activity in wavelengths that are responsive to endpointing. Predictive component 114 may provide non-responsive sensor channel data (including OES data of non-responsive wavelengths and other sensor data, in some embodiments) to model 190 and receive predicted sensor data as synthetic sensor data 162 in responsive wavelengths. Predictive component 114, model 190, client device 120, or another component may utilize the synthetic sensor data 162, in combination with current sensor data 146 of the same process operation in embodiments, to determine endpointing operations, to generate predictive data 168, etc. In some embodiments, model 190 may receive both responsive and non-responsive sensor data (e.g., sensor data from sensor channels that are both sensitive and not sensitive to process endpoints) and generate predictive data 168. In some embodiments, synthetic sensor data 162 may be predicted sensor data of a process that does not experience a process endpoint, e.g., a substrate that does not have an underlying layer revealed by an etch process, a substrate that does not reach the end or a process operation, or the like. Differences between predicted synthetic sensor data 162 and measured current sensor data 146 may be utilized to determine a process endpoint (e.g., by normalization of the measured data, subtraction of the measured data from the synthetic data, or another method of determining differences between the synthetic and measured sensor data).

In some embodiments, the various models discussed in connection with model 190 (e.g., supervised machine learning model, unsupervised machine learning model, etc.) may be combined in one model (e.g., an ensemble model), or may be separate models.

Data may be passed back and forth between several distinct models included in model 190 and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, synthetic sensor data 162, and predictive data 168.

Sensor data 142 may include historical sensor data 144 and current sensor data 146. Sensor data may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features, e.g., historical metrology data and current metrology data. Historical sensor data 144, historical metrology data, and historical manufacturing parameters may be historical data (e.g., at least a portion of these data may be used for training model 190). Current sensor data 146, current metrology data, may be current data (e.g., at least a portion to be input into learning model 190, subsequent to the historical data) for which predictive data 168 is to be generated (e.g., for performing corrective actions). Synthetic sensor data 162 may include synthetic trace spectral data generated by model 190, e.g., synthetic data that resembles OES data, or the like.

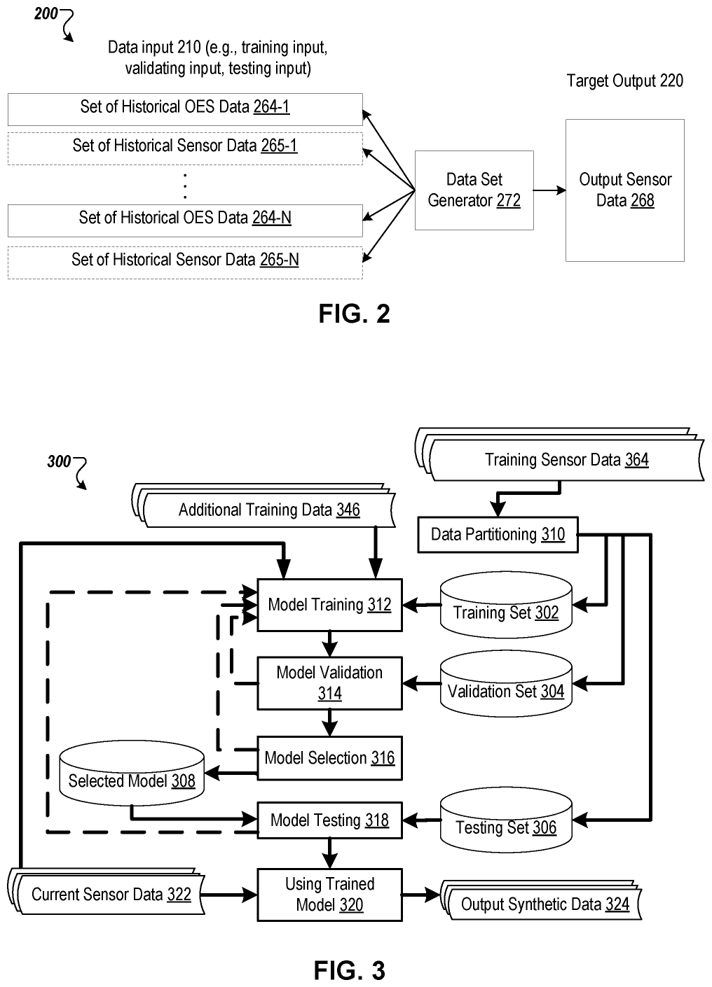

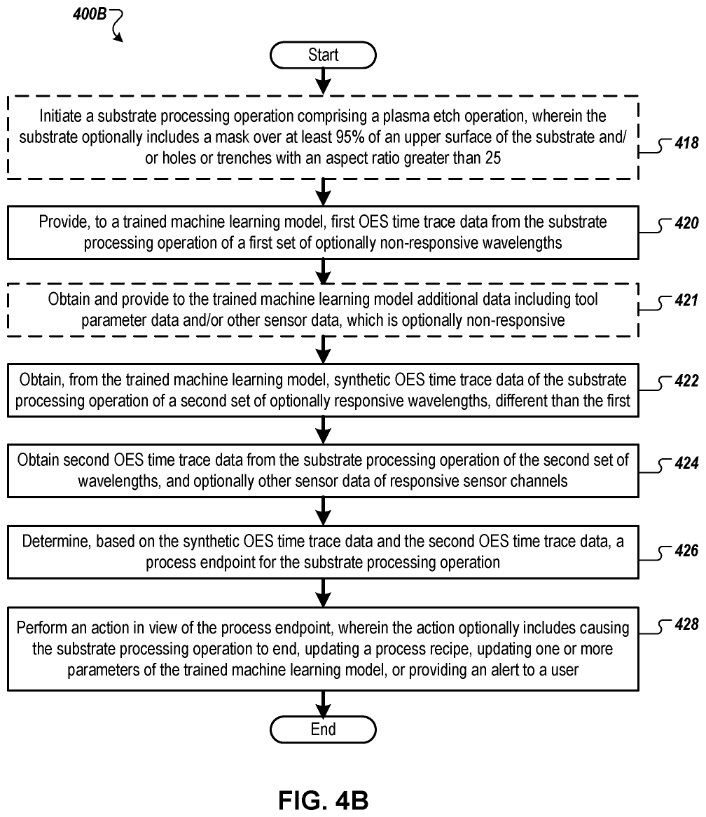

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition the historical data (e.g., historical sensor data 144, historical manufacturing parameters, historical metrology data) into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

In some embodiments, machine learning model 190 is provided historical data as training data. The historical data may be or include OES data in some embodiments. The historical data may include data associated with test substrates, substrates that do not experience process endpoints, reference substrates, etc. The type of data provided will vary depending on the intended use of the machine learning model. For example, a machine learning model may be trained by providing the model with historical sensor data 144 as training input and corresponding metrology data 160 as target output. In some embodiments, a large volume of data is used to train model 190, e.g., sensor and metrology data of hundreds of substrates may be used. In some embodiments, a fairly small volume of data is available to train model 190, e.g., model 190 is to be trained to recognize a rare event such as equipment failure, model 190 is to be trained to generate predictions of a newly seasoned or maintained chamber, etc.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model, collect that data into training, validation, and testing data sets, and use the data sets to train a second model (e.g., a machine learning model configured to output predictive data, corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Predictive component 114 may provide current data to model 190 and may run model 190 on the input to obtain one or more outputs. For example, predictive component 114 may provide current sensor data 146 to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data and/or synthetic data.

For purpose of illustration, rather than limitation, aspects of the disclosure describe the training of one or more machine learning models 190 using historical data (e.g., historical sensor data 144, historical manufacturing parameters) and inputting current data (e.g., current sensor data 146, current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical and/or synthetic data. In some embodiments, these models may be retrained utilizing a combination of true historical data and synthetic data. Predictive component 114 may monitor historical sensor data 144, historical manufacturing parameters, and metrology data 160. Any of the information described with respect to data input 210 of FIG. 2 may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, process control, or the like.

FIG. 2 depicts a block diagram of example data set generator 272 (e.g., data set generator 172 of FIG. 1) to create data sets for training, testing, validating, etc. a model (e.g., model 190 of FIG. 1), according to some embodiments. Data set generator 272 may be part of server machine 170 of FIG. 1. In some embodiments, several machine learning models associated with manufacturing equipment 124 may be trained, used, and maintained (e.g., within a manufacturing facility). Each machine learning model may be associated with one data set generators 272, multiple machine learning models may share a data set generator 272, etc.

FIG. 2 depicts a system 200 including data set generator 272 for creating data sets for one or more supervised models (e.g., model 190 of FIG. 1). Data set generator 272 may create data sets (e.g., data input 210, target output 220) using historical data and/or design rule data. In some embodiments, a data set generator similar to data set generator 272 may be utilized to train an unsupervised machine learning model, e.g., target output 220 may not be generated by data set generator 272.

Data set generator 272 may generate data sets to train, test, and validate a model. In some embodiments, data set generator 272 may generate data sets for a machine learning model. In some embodiments, data set generator 272 may generate data sets for training, testing, and/or validating a generator model configured to generate synthetic sensor data. The machine learning model is provided with set of historical OES data 264-1 and optionally set of historical sensor data 265-1 (e.g., sensor data that is not OES data) as data input 210. The machine learning model may be configured to accept OES data and/or other sensor data as input data and generate synthetic sensor data as output. The input sensor data (e.g., sets of historical OES data) may be of sensor channels that are not sensitive to endpointing (e.g., non-responsive wavelengths). Output sensor data 268 may be of sensor channels that are sensitive to process endpoint (e.g., responsive wavelengths).

Data set generator 272 may be used to generate data for any type of machine learning model that takes as input sensor data. Data set generator 272 may be used to generate data for a machine learning model that generates predicted metrology data of a substrate. Data set generator 272 may be used to generate data for a machine learning model configured to provide process control instructions. Data set generator 272 may be used to generate data for a machine learning model configured to identify a product anomaly and/or processing equipment fault. Data set generator 272 may be used to generate data for a machine learning model configured to recommend corrective actions, including maintenance, scheduling maintenance, process recipe updates, or the like.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data input 210 may include one or more sets of data. As an example, system 200 may produce sets of sensor data that may include one or more of sensor data from one or more types of sensors, combinations of sensor data from one or more types of sensors, patterns from sensor data from one or more types of sensors, and/or synthetic versions thereof.

In some embodiments, data set generator 272 may generate a first data input corresponding to a first set of historical OES data 264-1 to train, validate, or test a first machine learning model. Data set generator 272 may generate a second data input corresponding to a second set of historical metrology data (e.g., a set of historical OES data 264-2, not shown) to train, validate, or test a second machine learning model. Further sets of historical OES data may further be utilized in generating further machine learning models. Any number of sets of historical metrology data may be utilized in generating any number of machine learning models, up to a final set, set of historical OES data 264-N (N representing any target quantity of data sets, models, etc.), final set of historical sensor data 265-N, etc.

In some embodiments, data set generator 272 may generate a first data input corresponding to a first set of historical OES data 264-1 and/or a first set of sensor data 265-1 to train, validate, or test a first machine learning model. Data set generator 272 may generate a second data input corresponding to a second set of historical OES data 264-2 (not shown) and/or a second set of sensor data 265-2 (not shown) to train, validate, or test a second machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. In some embodiments, data set generator 272 may generate data for training a machine learning model configured to output realistic synthetic sensor data, by generating data sets including output sensor data 268. Data inputs 210 may also be referred to as “features,” “attributes,” or “information.” In some embodiments, data set generator 272 may provide the data set to training engine 182, validating engine 184, or testing engine 186, where the data set is used to train, validate, or test the machine learning model (e.g., one of the machine learning models that are included in model 190, ensemble model 190, etc.).

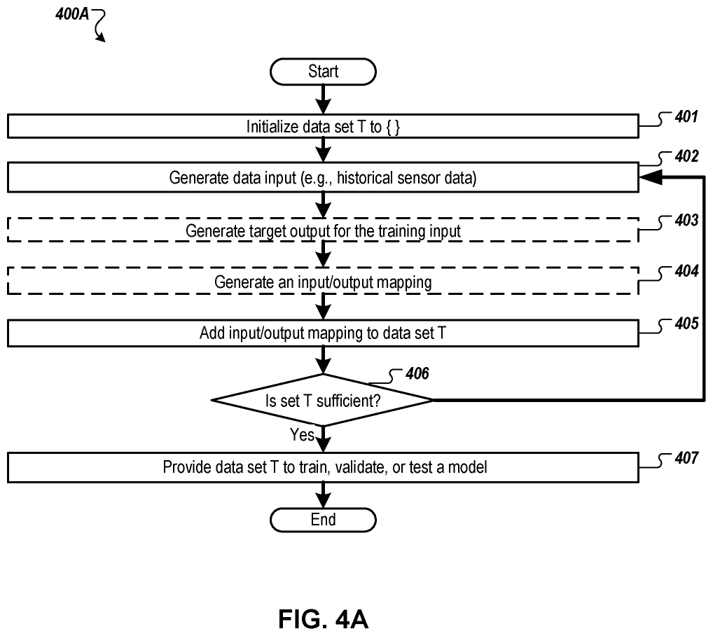

FIG. 3 is a block diagram illustrating system 300 for generating output data (e.g., synthetic sensor data 162 of FIG. 1), according to some embodiments. In some embodiments, system 300 may be used in conjunction with a machine learning model configured to generate predictive data, recommended corrective actions, perform endpointing or feedback control, etc. (e.g., predictive data 168 of FIG. 1). In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to cluster or classify substrates. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training sensor data 364 includes historical data, such as historical OES data, other historical sensor data, historical data of responsive and non-responsive sensor channels, etc. Training sensor data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training sensor data 364 includes sensor data from a variety of channels, including different sensors, different OES wavelengths, etc., including features derived from sensor data from 20 sensor channels (e.g., sensors 126 of FIG. 1), the sensor data may be divided into a first set of features including sensor channels 1-10 and a second set of features including sensor channels 11-20. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., a number of measured dimensions of a manufactured device, a cartoon picture of a manufactured device, etc.) to generate an output. The output may include, for example, synthetic sensor data resembling data from sensor channels not included in the input data. The output may be compared to a label of the training data item (e.g., actual measured sensor data from sensor channels not provided as input data).

Processing logic may then compare the generated output (e.g., synthetic sensor data) to the label (e.g., actual sensor data) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensor channels 1-10) and to generate a second trained model using the second set of features in the training set (e.g., sensor data from sensor channels 11-20). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being sensor data from sensor channels 1-15 and second set of features being sensor channels 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensor channels 1-10) and the second trained model using the second set of features in the validation set (e.g., sensor data from sensor channels 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensor channels 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current sensor data 322 and determines (e.g., extracts), from the output of the trained model, output synthetic data 324. Current sensor data 322 may be manufacturing parameters related to a process, operation, or action of interest. Current sensor data 322 may be related to manufacturing parameters related to a process under development, redevelopment, investigation, etc. Current sensor data 322 may be related to manufacturing parameters related to a gas transport system. Current sensor data 322 may include a number of sensor channels that are not responsive to process endpoints. Current sensor data 322 may include a number of OES wavelengths that are not responsive to process endpoints (e.g., responsiveness to process endpoints is below a threshold, satisfies a target condition, or the like).

A corrective action associated with the manufacturing equipment 124 of FIG. 1 may be performed in view of output synthetic data 324. In some embodiments, current sensor data 322 may correspond to the same types of features in the historical data used to train the machine learning model. In some embodiments, current sensor data 322 corresponds to a subset of the types of features in historical data that are used to train selected model 308. For example, a machine learning model may be trained using a number of sensor channels, and configured to generate output based on a subset of the sensor channels.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model by following operations described in connection with FIG. 3, etc.

Generation of a new model may include providing additional training data 346. Generation of a new model may further include providing current sensor data 322, e.g., data that has been used by the model to make predictions. In some embodiments, current sensor data 322 when provided for generation of a new model may be labeled with an indication of an accuracy of predictions generated by the model based on current sensor data 322. Additional training data 346 may be provided to model training of block 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current sensor data 322 and/or additional training data 346.

FIGS. 4A-B are flow diagrams of methods 400A-B associated with training and utilizing machine learning models, according to certain embodiments. Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-B may be performed, in part, by predictive system 110. Method 400A may be performed, in part, by predictive system 110 (e.g., server machine 170 and data set generator 172 of FIG. 1, data set generator 272 of FIG. 2A). Predictive system 110 may use method 400A to generate a data set to at least one of train, validate, or test a machine learning model, in accordance with embodiments of the disclosure. Method 400B may be performed by predictive server 112 (e.g., predictive component 114) and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-B.

For simplicity of explanation, methods 400A-B are depicted and described as a series of operations. However, operations in accordance with this disclosure can occur in various orders and/or concurrently and with other operations not presented and described herein. Furthermore, not all illustrated operations may be performed to implement methods 400A-B in accordance with the disclosed subject matter. In addition, those skilled in the art will understand and appreciate that methods 400A-B could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of sensor data, OES data, non-responsive sensor channel data, etc. In some embodiments, the first data input may include a first set of features for types of data and a second data input may include a second set of features for types of data (e.g., as described with respect to FIG. 3). Input data may include historical data and/or synthetic data in some embodiments. Input data may include reference data, e.g., data received from test process operations of test substrates, such as substrates that are designed such that a process endpoint will not occur during processing (e.g., substrates with a layer to be etched that is sufficiently thick to not be completely etched away during a duration of the test process operation).

In some embodiments, at block 403, processing logic optionally generates a first target output for one or more of the data inputs (e.g., first data input). In some embodiments, the input includes trace data of one or more non-responsive sensor channels (e.g., non-responsive OES wavelengths), and the target output includes trace data of one or more responsive sensor channels (e.g., OES wavelengths that are sensitive to endpointing). In some embodiments, input data may be in the form of sensor data and target output may be a list of components likely to be faulty, as in the case of a machine learning model configured to identify failing manufacturing systems. In some embodiments, no target output is generated (e.g., an unsupervised machine learning model capable of grouping or finding correlations in input data, rather than requiring target output to be provided).

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, or for performing a corrective action associated with manufacturing equipment 124.

FIG. 4B is a flow diagram of a method 400B for performing operations associated with process endpointing, according to some embodiments. At block 418, a substrate processing operation is initiated. Initiation of the substrate processing operation may be performed by processing logic, e.g., control logic of manufacturing equipment. Any process operation or operations may be performed on the substrate, the substrate may have undergone previous processes, or the like. An example of a process operation that may be associated with operations of this disclosure is a plasma etch operation, though other operations that include sensor signals that are responsive to endpointing and non-responsive to endpointing may also be performed. In some embodiments, operations described herein may be used for endpointing when conventional methods fail, e.g., due to small endpointing signals, low open area substrates, unusual or complex substrate designs or geometries, large background signals, or the like. Operations may be performed in association with a substrate that includes a low open area, e.g., an upper surface of the substrate to be etched may include a mask covering a large portion of the surface. In some embodiments, more than 85%, more than 90%, more than 95%, more than 97%, more than 98%, or more than 99% of an upper surface of a substrate may be covered by a masking material. A portion of the substrate that is unmasked may be the target for the etch process. A substrate may include masks covering any sub-range of these portions of a surface of the substrate. Operations may be performed in association with a substrate that includes holes or trenches with a large aspect ratio (e.g., ratio of a depth of the feature compared to a size of an opening for process gas to access the interior of the feature). The substrate may include large aspect ratio trench features, large aspect ratio hole features, or the like. In some embodiments, a diameter of a hole, the bottom of which is to be etched, may be less than 1% of the depth of the hold (e.g., aspect ratio greater than 100). Aspect ratios of features of substrate in connection with embodiments of the present disclosure may be greater than 20, greater than 25, greater than 50, greater than 100, etc. Features having aspect ratios of any subrange of these values may be included in substrates in connection with method 400B.

At block 420, processing logic provides, to a trained machine learning model, first OES time trace data from the substrate processing operation of a first set of wavelengths. The wavelengths may be non-responsive wavelengths, e.g., they may be insensitive (e.g., sensitivity below a target threshold) to process endpoint of the substrate processing operation. At block 421, processing logic obtains and provides to the trained machine learning model additional data including tool parameter data. For example, parameters controlling plasma production and properties, such as process gas, process gas mix, carrier gas, process gas pressure, temperature, plasma setpoints, etc., may be provided as input to the trained machine learning model. The trained model may be configured (e.g., trained) to predict properties or conditions of the chamber (e.g., responsive sensor channels) based on input sensor data (e.g., OES data), tool parameter data (e.g., process recipe data), etc. At block 421, processing logic may also obtain and provide further sensor data to the trained machine learning model. The further sensor data may also be non-responsive to process endpoint, and may include, for example, RF conditions, RF match voltages, currents, or capacitor positions, pressure or temperature conditions, gas flow conditions, flow valve actuator positions, etc. In some cases, such data may be responsive to process endpoint.

At block 422, processing logic obtains, from the trained machine learning model, synthetic OES time trace data of the substrate processing operation. The synthetic OES time trace data is of a second set of wavelengths, different than the first set. The synthetic OES time trace data may be of responsive wavelengths, e.g., wavelengths that are sensitive to process endpoint. The trained machine learning model (or models, in embodiments) may provide further synthetic data, such as synthetic data associated with other responsive sensor channels in addition to the synthetic OES data of responsive wavelengths.

At block 424, processing logic obtains second OES time trace data form the substrate processing operation. The second OES time trace data may be measured data from plasma of the substrate processing operation. The second OES time trace data may include data of the second set of wavelengths. The second OES time trace data may include data of responsive wavelengths and/or other responsive sensor channel. The second OES time trace data may be generated by a machine learning model trained to predict the behavior of responsive sensor channels in the absence of a process endpoint, e.g., training may be performed based on substrates that do not experience an endpoint.

At block 426, processing logic determines, based on the synthetic OES time trace data and the second OES time trace data, a process endpoint for the substrate processing operation. In some embodiments, the process endpoint may be determined based on differences between the synthetic OES time trace data and the measured second OES time trace data. In some embodiments, the process endpoint may be determined based on differences between a process operation that experiences a process endpoint (e.g., described by the second OES time trace data) and a process operation that does not experience a process endpoint (e.g., the synthetic OES time trace data). Other types of data may also be utilized in determining the process endpoint, e.g., other measured and/or synthetic sensor data.

At block 428, processing logic performs an action in view of the process endpoint. The action may include performing operations associated with process operation endpointing. The action may include causing the substrate processing operation to end. The action may include updating a process recipe. The action may include updating parameters of the trained machine learning model. The action may include providing an alert to a user.

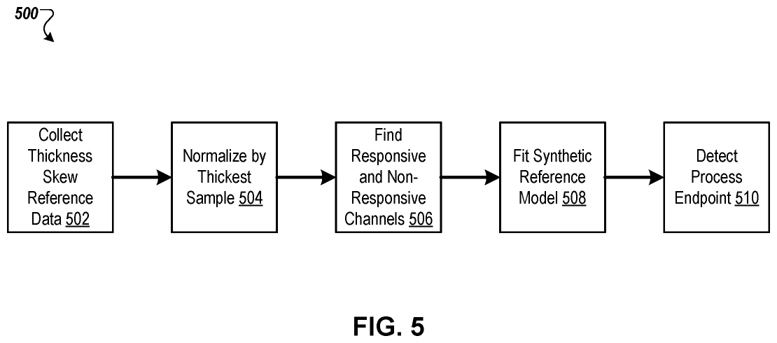

FIG. 5 is a block diagram of a data flow 500 for generating, verifying accuracy of, and/or using a machine learning model for endpointing based on responsive and non-responsive sensor channels, according to some embodiments.

At block 502, data collection operations are performed. Data collection may include thickness skew reference data, e.g., data on a number of substrates with different thicknesses of one or more layers. For example, substrates with progressively thicker upper layers may be generated and etched, for verifying the behavior of process endpoint as a function of etch layer thickness. Substrates with a thicker upper layer may take a longer time to reach a process endpoint, and such data may be useful for calibrating a model or process, or for verifying accuracy of an endpointing model-based procedure. In some embodiments, skew reference data may be utilized for training the machine learning model, e.g., thick substrate layers that are not associated with reaching an endpoint may generate data that is utilized for training a machine learning model. The model may be trained to generate synthetic data indicative of background plasma emission, e.g., plasma emission for a substrate that does not experience a process endpoint, that does not liberate particles of an underlying layer (e.g., ions or atoms that may emit light in the plasma cloud, which may be recorded in OES data), that does not exhibit properties of endpointing, or the like. The model may be trained to determine synthetic sensor data of responsive channels based on provided sensor data of non-responsive channels, e.g., for use in background correction for determining endpointing signals in the responsive channels. Data collection may include collecting data from a reference substrate processing operation. Data collection may include collecting reference OES time trace data.

At block 504, trace data may be normalized for comparing data from different samples. For example, trace data may be normalized based on data from the thickest sample (e.g., the reference substrate with the thickest upper layer which experiences endpointing after the largest processing time).

At block 560, responsive and non-responsive channels may be determined. Determining whether a sensor channel is responsive or non-responsive may be based on sensitivity of the sensor channel to process endpoint. Determining whether a sensor channel is responsive may be based on reference OES time trace data, e.g., based on data from reference substrates, from thickness skew experiments, etc. Normalized reference data may be utilized for determining responsive and non-responsive channels. Normalized sensor channels (e.g., OES wavelengths) sufficiently close to 1 (e.g., within a target threshold distance of 1) throughout a process endpoint may be classified as non-responsive channels. Normalized sensor channels of substrates that experience a process endpoint far from 1 (e.g., outside a target threshold distance from 1) in some portions of the data, in the vicinity in time of a process endpoint, or the like may be classified as responsive channels. Sensor data to be utilized in endpointing may be separated into responsive (to process endpoint) and non-responsive sets.

At block 508, a synthetic reference model is fit. Fitting a synthetic reference model may include providing data to a trained machine learning model. Fitting a synthetic reference model may include providing non-responsive data to a trained machine learning model. The trained machine learning model may generate synthetic data (e.g., synthetic OES data) in responsive channels. The trained machine learning model may be trained to predict plasma emission background, which may then be used to extract endpoint information from OES data. The trained machine learning model may be trained to predict sensor data values as though no endpoint was achieved.

At block 510, process endpoint is detected. Detecting the process endpoint may include comparing synthetic data in responsive channels to measured data in responsive channels. Detecting the process endpoint may include normalization of responsive channel data. Detecting the process endpoint may include determining values far from one of a function including measured responsive sensor channel values divided by synthetic responsive sensor channel values, e.g., determining times when modeling responsive values associated with a substrate with no endpointing, associated with background plasma emission, or the like, differ from responsive values measured in the substrate processing chamber.

Performing operations such as those described in connection with FIGS. 4A-B and FIG. 5 provide advantages over conventional methods. These operations enable real time endpointing of a process operation in progress when a single channel may not include a sufficiently strong signal for determining process endpoint. The operations enable endpointing in cases where a simple combination of sensor channels (e.g., dividing a responsive channel by an unresponsive channel, for instance) may not be sufficient to determine process endpoint. The operations enable endpointing in cyclical operations, where and endpoint may be reached in any of several cycles, without utilizing information from one cycle (which may or may not be relevant to data from later cycles, as the geometry of the substrate continues to change, for example) as reference data for a later cycle. Reference data may be generated based on the real-time collection of non-responsive channel data, and may enable more agile and accurate endpointing procedures. Reference data may be based on modeling from a current substrate, and may involve less (or no) periodic re-training or repeating of generation of reference data, reducing costs associated with generating and disposing of reference substrates.

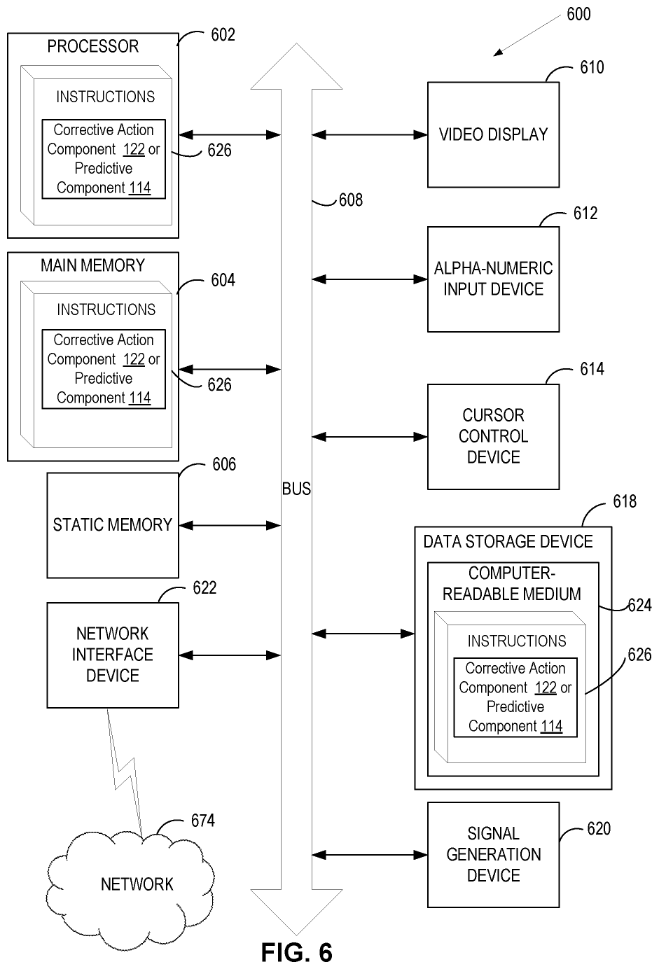

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method comprising:
providing, to a trained machine learning model, first optical emission spectroscopy (OES) time trace data from a substrate processing operation, the first OES time trace data being of a first set of wavelengths;
obtaining, from the trained machine learning model, synthetic OES time trace data of the substrate processing operation, the synthetic OES time trace data being of a second set of wavelengths, different than the first;
obtaining second OES time trace data from the substrate processing operation of the second set of wavelengths;
determining, based on the synthetic OES time trace data and the second OES time trace data, a process endpoint for the substrate processing operation; and
performing an action in view of the process endpoint.

2. The method of claim 1, wherein the first set of wavelengths comprise wavelengths that are non-responsive to the process endpoint, and the second set of wavelengths comprise wavelengths that are responsive to the process endpoint.

3. The method of claim 1, wherein the action comprises one or more of:
causing the substrate processing operation to end;
updating a process recipe;
updating one or more parameters of the trained machine learning model; or
providing an alert to a user.

4. The method of claim 1, wherein the substrate processing operation comprises a plasma etch operation performed on a substrate.

5. The method of claim 4, wherein the substrate comprises an upper surface that comprises a mask, wherein the mask comprises at least 95% of a surface area of the upper surface, and wherein the process endpoint comprises a target etch of an unmasked portion of the upper surface.

6. The method of claim 1, further comprising obtaining a set of tool parameter data associated with the substrate processing operation, wherein the synthetic OES time trace data is based on the set of tool parameter data.

7. The method of claim 1, further comprising determining the first set of wavelengths based on reference OES time trace data associated with a reference substrate processing operation, wherein determining the first set of wavelengths comprises:
obtaining the reference OES time trace data, wherein the reference OES time trace data is associated with a reference substrate which does not experience a target process endpoint during the reference substrate processing operation;
obtaining second OES time trace data, wherein the second OES time trace data is associated with a second substrate which does experience the target process endpoint during a second substrate processing operation; and
determining the first set of wavelengths based on behavior of the reference OES time trace data and the second OES time trace data.

8. A non-transitory machine-readable storage medium, storing instruction which, when executed, cause a processing device to perform operations comprising:
providing, to a trained machine learning model, first optical emission spectroscopy (OES) time trace data from a substrate processing operation, the first OES time trace data being of a first set of wavelengths;
obtaining, from the trained machine learning model, synthetic OES time trace data of the substrate processing operation, the synthetic OES time trace data being of a second set of wavelengths, different than the first;
obtaining second OES time trace data from the substrate processing operation of the second set of wavelengths;
determining, based on the synthetic OES time trace data and the second OES time trace data, a process endpoint for the substrate processing operation; and
performing an action in view of the process endpoint.

9. The non-transitory machine-readable storage medium of claim 8, wherein the first set of wavelengths comprise wavelengths that are non-responsive to the process endpoint, and the second set of wavelengths comprise wavelengths that are responsive to the process endpoint.

10. The non-transitory machine-readable storage medium of claim 8, wherein the action comprises one or more of:
causing the substrate processing operation to end;
updating a process recipe;
updating one or more parameters of the trained machine learning model; or
providing an alert to a user.

11. The non-transitory machine-readable storage medium of claim 8, wherein the substrate processing operation comprises a plasma etch operation performed on a substrate comprising an upper surface that comprises a mask, wherein the mask comprises at least 95% of a surface area of the upper surface, and wherein the process endpoint comprises a target etch of an unmasked portion of the upper surface.

12. The non-transitory machine-readable storage medium of claim 8, wherein the substrate processing operation comprises a plasma etch operation performed on a substrate comprising a hole or trench feature, wherein the hole or trench feature has a depth at least fifty times larger than a size of an opening to the hole or trench feature.

13. The non-transitory machine-readable storage medium of claim 8, wherein the operations further comprise determining the first set of wavelengths based on reference OES time trace data associated with a reference substrate processing operation.

14. The non-transitory machine-readable storage medium of claim 13, wherein determining the first set of wavelengths comprises:
obtaining the reference OES time trace data, wherein the reference OES time trace data is associated with a reference substrate which does not experience a target process endpoint during the reference substrate processing operation;
obtaining second OES time trace data, wherein the second OES time trace data is associated with a second substrate which does experience the target process endpoint during a second substrate processing operation; and
determining the first set of wavelengths based on behavior of the reference OES time trace data and the second OES time trace data.

15. A system, comprising memory and a processing device coupled to the memory, wherein the processing device is configured to:
provide, to a trained machine learning model, first optical emission spectroscopy (OES) time trace data from a substrate processing operation, the first OES time trace data being of a first set of wavelengths;
obtain, from the trained machine learning model, synthetic OES time trace data of the substrate processing operation, the synthetic OES time trace data being of a second set of wavelengths, different than the first;
obtain second OES time trace data from the substrate processing operation of the second set of wavelengths;
determine, based on the synthetic OES time trace data and the second OES time trace data, a process endpoint for the substrate processing operation; and
perform an action in view of the process endpoint.

16. The system of claim 15, wherein the first set of wavelengths comprise wavelengths that are non-responsive to the process endpoint, and the second set of wavelengths comprise wavelengths that are responsive to the process endpoint.

17. The system of claim 15, wherein the action comprises one or more of:
causing the substrate processing operation to end;
updating a process recipe;
updating one or more parameters of the trained machine learning model; or
providing an alert to a user.

18. The system of claim 15, wherein the substrate processing operation comprises a plasma etch operation performed on a substrate comprising an upper surface that comprises a mask, wherein the mask comprises at least 95% of a surface area of the upper surface, and wherein the process endpoint comprises a target etch depth of an unmasked portion of the upper surface.

19. The system of claim 15, wherein the processing device is further configured to obtain a set of tool parameter data associated with the substrate processing operation, wherein the synthetic OES time trace data is based on the set of tool parameter data.

20. The system of claim 19, wherein the set of tool parameter data comprises one or more of:
flow valve actuator position;
chamber pressure;
radio frequency (RF) match voltage;
RF match current; or
RF match capacitor position.
